(19) United States
(12) Patent Application Publication
(10) Pub. No.: US 2008/0189569 A1
(43) Pub. Date: Aug. 7, 2008

(54) Adjusting performance method for multi-core processor

(75) Inventor: Shao-Kang Chu, Taipei (TW)

Correspondence Address: BACON & THOMAS, PLLC, 625 SLATERS LANE, FOURTH FLOOR, ALEXANDRIA, VA, 22314, US

(73) Assignee: ASUSTek COMPUTER INC., Taipei (TW)

(21) Appl. No.: 12/010,776

(22) Filed: Jan. 30, 2008

(30) Foreign Application Priority Data
Feb. 7, 2007 (TW) 96104497

(51) Int. Cl. G06F 9/46; G06F 1/08

(52) U.S. Cl. 713/600; 718/100

(57) ABSTRACT

An adjusting performance method for a multi-core processor is provided. A plurality of processing cores of the multi-core processor at least includes a first processing core and a second processing core. The adjusting performance method includes the steps of detecting the multi-threadedness of the multi-core processor and the load of the processing cores to obtain a detecting result in the step (a), determining whether the operation bottleneck is concentrated on one processing core of the processing cores according to the detecting result in the step (b), and adjusting the operating frequency of the first processing core according to the multi-threadedness of the multi-core processor if the operation bottleneck occurs at the first processing core in the step (c).

This application claims the benefit of Taiwan application Serial No. 96104497, filed Feb. 7, 2007, the subject matter of which is incorporated herein by reference.

### BACKGROUND OF THE INVENTION

1. Field of the Invention

The invention relates to a multi-core processor and, more particularly, to an adjusting performance method for a multi-core processor.

2. Description of the Related Art

Nowadays, many manufacturers develop the technology related to the multi-core processor, so that the multi-core processor gradually becomes a market trend.

However, even if the multi-core processor system cooperates with an operating system which can support the multi-processor, if the application program has not been re-programmed or re-compiled for the multi-processor system, and only can be executed in a single process or a single thread mode, and the application program only can be dispatched to a single processing core thereof to be executed. At that moment, if no other processing program needs to be executed, other processing cores just keep idle and do not cooperate with the busy core to increase the operation execution. Also, if the application program had not been optimized for the multi-processor system at the programming or compiling stage, the data dispatched in each core would be likely to be relevant with each other and not completely independent. At that moment, one processing core thereof may not be capable of completing the operation that it is responsible for until it receives the output result of the other processing cores, so that the processor cores cannot bring their operation ability into play fully simultaneously. That is, the system performance is limited by the operation speed of a single core instead of the overall operation ability of the multi-core processor.

Conventionally, although directly replacing the multi-core processor with a multi-core processor having a higher frequency can provide a relatively better performance for these kinds of process, however, the power consumption of the processor is also largely increased. The reason for the above is that the power consumption (P) of the semiconductor is increased in an equal proportion with the increase of the operating frequency (f) in the operation (that is, P=c×f×V², wherein c is the semiconductor characteristic parameter of the processor, and V is the operating voltage of the processor). Moreover, the more the interior cores of the processor are, the more the power consumption is (as shown in table 1). Therefore, the whole system needs to reserve extra design margin for the power delivery and preferred heat dissipation ability.

TABLE 1
Difference Comparison of Power Consumption of the Multi-core
processor in Different Operating Frequency

| | | | quad |
|---|---|---|---|
| | single | dual processing | processing |
| operating frequency | processing core | cores | cores |
| when the initial operating | X | 2X | 4X |
| frequency is f | | | |
| when the operating | 1.25X | 2.5X | 5X |
| frequency is | | | |
| increased by 25% to be | | | |
| 1.25 × f | | | |
| difference of power | 0.25X | 0.5X | X |
| consumption | | | |

wherein, X indicates the power consumption of a single processing core in an original operating frequency.

Therefore, although the multi-core processor has operating ability which is multiple of that of single-core processor theoretically, when the operation bottleneck is concentrated on a single core of the multi-core processor, the improvement of the overall performance of the multi-core processor is still limited, and the multi-task processing advantage relative to the single-core processor in the anticipation cannot be performed.

### BRIEF SUMMARY OF THE INVENTION

The objective of the invention is to provide an adjusting performance method for a multi-core processor to decrease the operation bottleneck when the load concentrates on one core of a multi-core processor and provide the throughput improvement for the overall performance of the multi-core processor.

According to the objective of the invention, an adjusting performance method for a multi-core processor is provided. A plurality of processing cores of the multi-core processor includes at least a first processing core and a second processing core. The adjusting performance method includes the following steps of detecting the multi-threadedness of the multi-core processor and the load of the processing cores to obtain a detecting result in step (a), determining whether the operation bottleneck is concentrated on one of the processing cores according to the detecting result in step (b), and adjusting the operating frequency of the first processing core according to the multi-threadedness of the multi-core processor if the operation bottleneck happens in the first processing core in step (c).

In one embodiment of the invention, the step (c) further includes the step of increasing the multiplier, clock or power supply of the first processing core.

In one embodiment of the invention, the multi-core processor is operatively connected to the control unit and the clock generator. The control unit is operatively connected to the processing cores and the clock generator, respectively. The clock generator is operatively connected to the processing cores, respectively. The control unit increases the clock of the processing cores by controlling the clock generator.

In one embodiment of the invention, the control unit controls the clock generator by the Inter-integrated Circuit (I²C) Bus, and then the clock of the first processing core can be controlled by programming the clock generator via the I²C Bus.

In one embodiment of the invention, the step (c) further includes the step of adjusting the operating frequency, the power state or the power supply according to the multi-threadedness of the multi-core processor.

In one embodiment of the invention, in the step (a), the multi-threadedness of the multi-core processor and the load of the processing cores are detected in a hardware monitoring means or a software monitoring means.

These and other features, aspects, and advantages of the present invention will become better understood with regard to the following description, appended claims, and accompanying drawings.

### BRIEF DESCRIPTION OF THE DRAWINGS

FIG. 1 is a block diagram showing a multi-core processor system according to one embodiment of the invention.

FIG. 2 is a flowchart showing an adjusting performance method for a multi-core processor according to first embodiment of the invention.

FIG. 3 is a flowchart showing an adjusting performance method for a multi-core processor according to second embodiment of the invention.

### DETAILED DESCRIPTION OF THE EMBODIMENTS

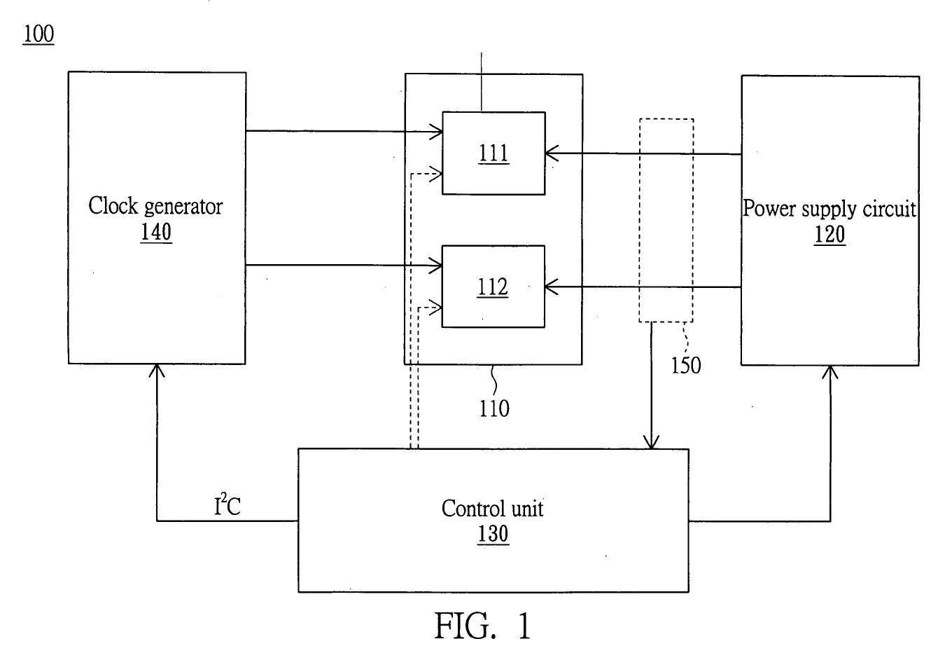

FIG. 1 is a block diagram showing a multi-core processor system of one embodiment of the invention. The multi-core processor system 100 includes a multi-core processor 110, a power supply circuit 120, a control unit 130, a clock generator 140 and a detecting unit 150. The multi-core processor 110 includes at least a first processing core 111 and a second processing core 112.

The multi-core processor 110, the power supply circuit 120, the control unit 130, the clock generator 140 and the detecting unit 150 are all assembled at the motherboard (not shown) of the multi-core processor system 100. The power supply circuit 120 is operatively connected to the first processing core 111 and the second processing core 112 of the multi-core processor 110, respectively, to provide the power for the processing cores 111 and 112. In the embodiment, the power supply circuit 120 can be a voltage regulator module (VRM).

The control unit 130 is operatively connected to the multi-core processor 110, the power supply circuit 120, the clock generator 140 and the detecting unit 150, respectively. The control unit 130 is operatively connected to the first processing core 111 and the second processing core 112 of the multi-core processor 110. The clock generator 140 is operatively connected to the first processing core 111 and the second processing core 112 of the multi-core processor 110.

The control unit 130 of the embodiment can control the power supply that is outputted to the processing cores 111 and 112 by the power supply circuit 120. The control unit 130 also can control the multiplier and the power state of the processing cores 111 and 112, respectively. In addition, the control unit 130 further can control the clock generator 140 to provide the clock (also called external frequency) for the processing cores 111 and 112 via the Inter-integrated Circuit (I2C) bus. In other embodiment, the control unit 130 also can control the clock generated by the clock generator 140 via other interface. Thus, the control unit 130 can adjust the operating frequency of the processing cores 111 and 112.

In the embodiment, the control unit 130 is a south bridge chip. In other embodiments, the control unit 130 may be a super IO chip or other chipset having the same effect.

The detecting unit 150 is operatively connected to the power pins of the processing cores 111 and 112 and the control unit 130, respectively, thereby detecting the load current or voltage of the processing cores 111 and 112, so that the control unit 130 can determine the load of the processing cores 111 and 112. Namely, the detecting unit 150 can use the working mode of the pulse-width-modulation (PWM) controller of the plurality of voltage regulator modules of the power supply circuit 120, so that the multi-core processor system can utilize the duty cycle signal of the PWM controller to detect the load current of the processing cores 111 and 112. In other embodiment, the detecting unit 150 may be implemented by an operational amplifier cooperated with a plurality of comparison circuits achieved by resistances, so that the multi-core processor system can utilize the comparison circuits with impedance to detect the load current and output the detecting result to the control unit 130, thereby, achieving the objective of monitoring the usage rate of the processing cores 111 and 112 in the hardware monitoring means.

In other embodiment of the invention, the multi-core processor system 100 also can use a software monitoring means to monitor the load of the processing cores 111 and 112. For example, the operating system which has a built-in task manger to provide the monitoring information such as the CPU load (or called CPU utilization) or an application program which can monitor the load of the processing core 111 and 112, so that the performance of the processing cores 111 and 112 can be properly adjusted (which is described in detail hereinbelow). The description relative to the efficiency adjustment for the processing cores 111 and 112 is described hereinbelow.

The multi-core processor system 100 provided by one embodiment of the invention can support the multi-tasking operation, and the operating system installed in the multi-core processor system 100 also can use the performance counter to trace the command operation in the charge of each processing core to detect the multi-threadedness of the multi-core processor 110.

For example, the multi-core processor system 100 can use the performance counter of the operating system to compute the proportion of the single thread and the multi-thread that a series of command operation of the computer program corresponds to in a period of time to be the multi-threadedness. For example, the higher the multi-threadedness is, the more the multi-core processor 110 is dependent on the multi-tasking processing ability of the processing cores 111 and 112 when the computer program is executed (the less the situation of the load concentration occurs); on the contrary, the lower the multi-threadedness is, the more the performance of a single processing core is directly related when the computer program is executed (the more the situations of the load concentration occurs). Therefore, the control unit 130 provided by the embodiment can adjust the operation performance of each processing core with different load according to the multi-threadedness to increase the whole processing efficiency of the multi-core processor 110.

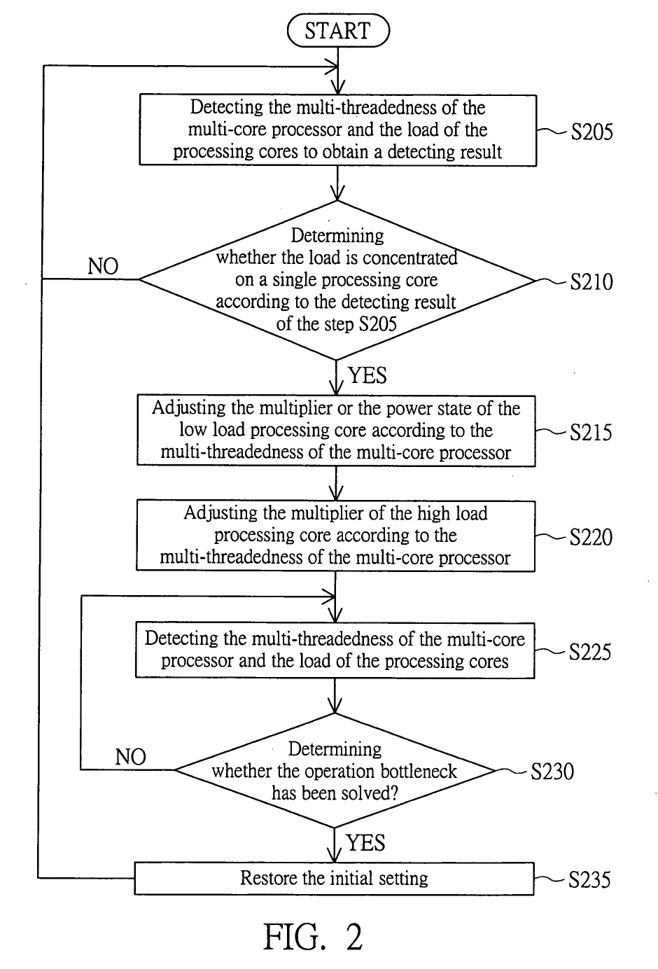

FIG. 2 is a flowchart showing an adjusting performance method for a multi-core processor of a first embodiment of the invention. In the step S205, the multi-threadedness of the multi-core processor 110 and the load of the processing cores 111 and 112 can be detected by a hardware monitoring means or by a software monitoring means to obtain a detecting result.

In the step S210, the control unit 130 determines whether the load (or the operation bottleneck) is concentrated on a single processing core according to the detecting result obtained in the step S205. That is, the control unit 130 determines whether the difference value between the load of the first processing core 111 and the load of the second processing core 112 is greater than a default value.

In the embodiment, the operation bottleneck and the load concentration mean the same state. That is, as for one processing core (such as the processing core 111) of the processing cores 111 and 112, no matter the processing core (the processing core 111) is in a single task operation (the lower multi-threadedness), or the other processing cores waits for the operation result of the processing core (the processing core 111), for the processing core (the processing core 111), the instant load only is concentrated on the processing core (the processing core 111), that is, the operation bottleneck is at the processing core (the processing core 111).

For example, if the load of the first processing core 111 is greater than the load of the second processing core 112, and the load difference value is greater than a predetermined value, the control unit 130 determines that the load is concentrated on the first processing core 111. And then, the step S215 and the step S220 are executed.

In the step S210, if the control unit 130 determines that the load is not concentrated on a single processing core, the control unit 130 does not adjust the multi-core processor 110 and maintain the present operating setting (such as an initial setting or other operating setting) of the multi-core processor 110. And then, the step S205 is executed.

In the step S215, the control unit 130 adjusts the multiplier or the power state of the low load processing core according to the multi-threadedness of the multi-core processor 110. The control unit 130 can change the power state (described in detail hereinbelow) of the low usage rate processing core or decrease the multiplier of the low usage rate processing core for decreasing the power consumption of the multi-core processor 110. In the step S220, the control unit 130 adjusts the multiplier of the high load processing core according to the multi-threadedness of the multi-core processor 110. The control unit 130 can adjust the operating setting of the processing core by a built-in look-up table to make each processing core have the needed multiplier or the power state. The look-up table includes, for example, the relative data shown in following table 2.

TABLE 2

| | the power state | the multiplier | the multiplier of |
|---|---|---|---|
| | of the low load | of the low load | the high load |
| multi-threadedness | processing core | processing core | processing core |
| higher than 30% | C0 | R | R |
| 20~30% | C1 | R − 2 | R + 1 |
| 10~20% | C2 | R − 4 | R + 2 |
| lower than 10% | C3 | R − 6 | R + 3 |

The multiplier of each processing core can be switched between the values such as 1.5 to 20 (depend on the used processor). In the table 2, R indicates the original multiplier (such as 12) in the initial setting, and the R+1 indicates the upper grade multiplier (such as 13) which is greater than R, while R−1 indicates the lower grade multiplier (such as 11, and R−2 is 10) which is less than R, and then the others are by parity of reasoning.

In the table 2, C0˜C3 denote the power state of each processing core. The C0 indicates that the power state of the processing core is C0-Active, C1 indicates that the power state of the processing core is C1-Halt, C2 indicates that the power state of the processing core is C2-Stop Clock, and C3 indicates that the power state of the processing core is C3-Deep Sleep. Certainly, in other embodiments, the power state of the processing cores 111 and 112 provided in the embodiment also can be switched to the C4-Deeper Sleep.

The control unit 130 further can adjust the operation speed of the processing cores 111 and 112 by the enhanced Intel speed-step technology (EIST) to greatly decrease the power provided for the low load processing cores 111 and 112, and then the high temperature and high electricity consumption of the system are improved.

From the above, if the control unit 130 determines that the first processing core 111 is high load, and the second processing core 112 is low load relatively, and the multi-threadedness of the multi-core processor 110 is known to be 15% in the step S205, the control unit 130 can decrease the multiplier of the second processing core 112 to R−4 from the R (take the processing cores 111 and 112 whose multi-threadedness is higher than the 30% in the initial setting as example) or switch the power state from C0 to C2 (step S215), and then increase the multiplier of the first processing core 111 from R to R+2 (step S220) to increase the operation performance of the processing core with high load, and thereby to shorten the time of the load concentration and save the useless power consumption of the low load processing core.

If the multi-threadedness falls into other range, the control unit 130 also can make the adjustment with different extent by contrasting with the table 2 according to the multi-threadedness to adjust operating setting of the processing cores 111 and 112 to the operating setting that the multi-threadedness in the look-up table corresponds to. For example, when the multi-threadedness is 25%, although the load is concentrated on a single processing core, but it is higher than the 15%, which means the time of the load concentration is shorter, so that the adjustment extent of the multiplier or the power state of the processing core with the high load and the low load can be less to make the average processing efficiency of the multi-processor 110 in a long time preferred. On the contrary, for example, the multi-threadedness is 9%, the adjustment extent of the multiplier or the power state of the processing core with the high load and the low load is greater than that in the situation that the multi-threadedness is 15%.

In the step S225, the multi-threadedness of the multi-core processor 110 and the load of the processing cores 111 and 112 are continuously detected, and the detecting result is outputted to the control unit 130, so that the control unit 130 can determine whether the operation bottleneck has been solved (step S230). If the operation bottleneck has not been solved, the step S225 is continuously executed. If the operation bottleneck has been solved, the step S235 is executed, and the initial setting is restored by the control of the control unit 130, and then the step S205 is continuously executed.

In the other embodiment, if the operation bottleneck has not been solved, the control unit 130 can determine whether the difference value between the processing cores is less than that before the adjustment; if it is yes, the operating setting after the first adjustment for the processing cores 111 and 112 can be maintained, and the step S225 is also executed continuously. Or if the load difference value between the processing cores is still greater than a predetermined value, the step S215 and the step S220 are continuously executed to adjust the operating setting of the processing cores 111 and 112.

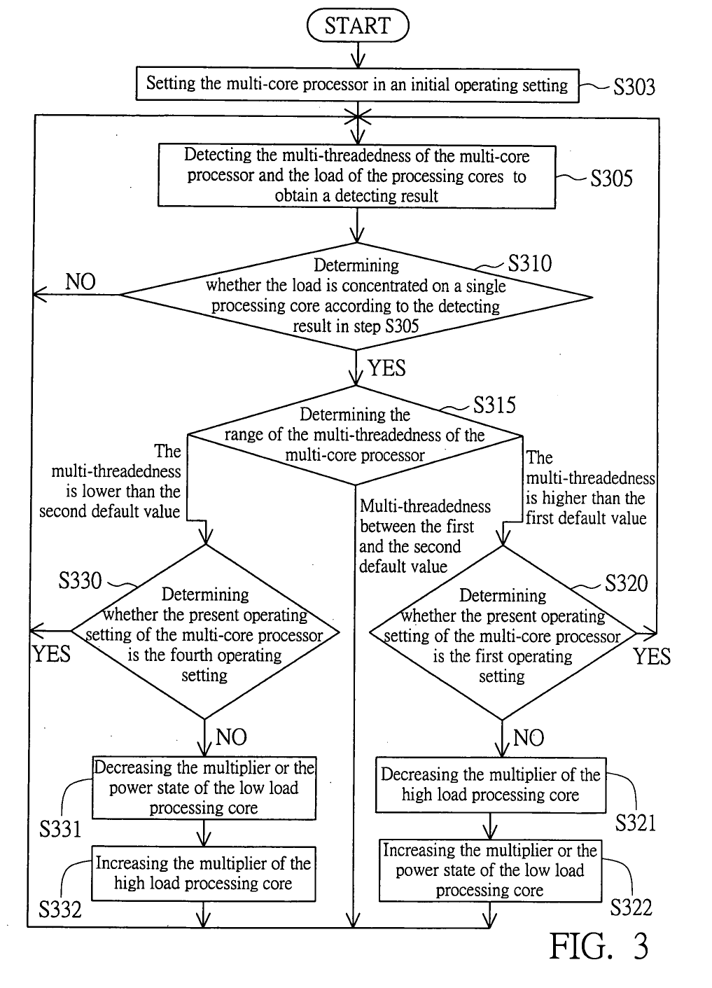

FIG. 3 is a flowchart showing an performance adjustment method for a multi-core processor according to the second embodiment of the invention. First, in the step S303, the multi-core processor is set in an initial operating setting. In the second embodiment, the control unit 130 can have, for example, a built-in look-up table including the relative data shown in the following table 3. The definitions of the symbols are the same with that in table 2, and they are not described herein for concise purpose. The initial operating setting is, for example, a first operating setting, and all the processing cores in the multi-core processor 110 are set to have initial multiplier (R) and the power state (C0) in a normal operation.

TABLE 3

| | the power state | the multiplier | the multiplier |
|---|---|---|---|
| | of the low load | of the low load | of the high |
| operating setting | processing core | processing core | load processing core |
| the first operating | C0 | R | R |
| setting | | | |
| the second | C1 | R − 2 | R + 1 |
| operating setting | | | |
| the third | C2 | R − 4 | R + 2 |
| operating setting | | | |
| the fourth | C3 | R − 6 | R + 3 |
| operating setting | | | |

The difference between the FIG. 2 and FIG. 3 is that the second embodiment uses different means to adaptively adjust the processing core. As shown in FIG. 3, if it is determined that the load is concentrated on a single processing core in the step S310, the step S315 is executed to determine the range of the multi-threadedness of the multi-core processor 110. For example, when it is determined that the multi-threadedness is higher than a first default value (such as 30%), the step S320 is executed; when it is determined that the multi-threadedness is lower than a second default value (such as 10%), the step S330 is executed; when it is determined that the multi-threadedness is between the first and the second default value, the present operating setting is maintained, and the step of returning to the step S305 is executed.

When the step S305 is executed, the multi-core processor 110 may be in the first operating setting (come from the step S303) or in other operating settings after the adjustment in the steps S321, S322, S331 and S332. If the means of the first embodiment is used, the control unit 130 directly adjusts the processing cores to the operating setting that the multi-threadedness corresponds to only according to the look-up table including the table 2. In the second embodiment, for the same multi-threadedness, the adjustment is different because of the different operating setting of the multi-core processor 110 in detecting.

For example, when the multi-threadedness is detected to be 9%, in the step S215 of the first embodiment, the multiplier of the low load processing core is directly adjusted to R−6, or the power state is adjusted to C3, and the multiplier of the high load processing core is adjusted to R+3 (please refer to table 2), no matter what operating setting is when the multi-core processor 110 is detected. In the second embodiment, when the multi-threadedness is lower than 10%, the step S330 is executed first to determine whether the present operating setting of the multi-core processor is the fourth operating setting. If the operating setting is the first to third operating setting, the step S331 is entered into.

For example, if the multi-core processor 110 is in the first operating setting when the step S205 is executed to detect, after the step S331 is entered into and follows the step S330, the multiplier of the low load processing core is decreased from the R to R−2 (instead of being directly adjusted to R−6), or the power state is adjusted from C0 to C1 (instead of C3). In the following step S332, the multiplier of the high load processing core is increased from R to R+1 (instead of R+3). In other words, the control unit 130 adjusts the operating setting of the processing cores 111 and 112 from the i-th (or the first) operating setting to the (i+1)-th (or the second) operating setting in the table 3, and then the program is continuously executed, and the steps S305 and S310 are executed.

When the multi-core processor 110 is in the (i+1)-th operating setting, if it is determined that the load concentration still exists by the steps S305, S310 and S315, and the multi-threadedness is still lower than 10%, since the operating setting has not been adjusted to the fourth operating setting, the steps S331 and S332 are executed to adjust the (i+1)-th operating setting of the processing cores 111 and 112 to the (i+2)-th operating setting. On the contrary, if it is determined that the load concentration still exists by the steps S305, S310 and S315, and the multi-threadedness is, for example, 35%, since the operating setting has not been adjusted to the first operating setting, the steps S321 and S322 are entered into and follows the step S320 to adjust the (i+1)-th operating setting of the processing cores 111 and 112 to the i-th operating setting. The objective of executing the determining operation of the steps S320 and the step S330 is to assure that the multi-core processor 110 can operate in several operating settings supported by the control unit 130. Take the table 3 as an example, the multi-core processor 110 operates between the first operating setting and the fourth operating setting.

On the other hand, if it is determined that the load concentration still exists by the step S305, S310 and S315, but the multi-threadedness is between the first and the second default value (such as 10-30%), the present operating setting is maintained, and then the step of directly returning to the step S305 is executed. That is, the operating setting of the processing cores 111 and 112 in detecting is gradually adjusted to be close to or away from the first operating setting according to the range of the multi-threadedness, or the present operating setting may be maintained. Since the multi-threadedness may change slightly frequently or fall rapidly in a short time; at that moment, if the multiplier or the power state of each processing core is changed directly correspondingly to the multi-threadedness, the processing core may be switched between two operating setting frequently, or a longer switch time is needed to switch to another operating setting which is quite different, which affects the overall average performance of the multi-core processor 110 in a long period. Therefore, the operating setting can be adjusted gradually by the adjusting means of the second embodiment, or the present operating setting can be maintained in an elastic range between the first and second default value to control each processing core.

Certainly, when the operation performance of the processing cores 111 and 112 is adjusted, the clock (external frequency) can also be adjusted. Generally speaking, the external frequency of the processing cores 111 and 112 can be 50, 60, 66.6, 75, 83.3, 95, 100, 112, 124, 133, . . . , 333 MHz and so on. That is, the control unit 130 also can change the external frequency of each processing core in a manner like the adjustment manner for the multiplier shown in table 2 and table 3. In addition, the control unit 130 also can control the amount of the electric power that the power supply circuit 120 provides for the processing cores 111 and 112 to meet the change of the operating frequency.

To sum up, in the embodiment of the invention, the multi-threadedness of the multi-core processor 110 and the load of the processing cores 111 and 112 can be detected in a hardware monitoring means or in a software monitoring means. Thereby, the control unit 130 can make a proper performance adjustment for the processing cores with different load according the multi-threadedness to increase the overall performance of the multi-core processor 110 and save the electricity.

In the adjusting performance method for the multi-core processor disclosed by the embodiment of the invention, the operating setting of each processing core can be adjusted according to the multi-threadedness of the multi-core processor, so that the overall efficiency of the multi-core processor can be optimized and the time of the operation bottleneck can be shortened.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An adjusting performance method for a multi-core processor having processing cores of a first processing core and a second processing core, the adjusting performance method comprising the steps of:
(a) detecting the multi-threadedness of the multi-core processor and the load of the processing cores to obtain a detecting result;
(b) determining whether the operation bottleneck is concentrated on one processing core of the processing cores according to the detecting result; and
(c) adjusting the operating frequency of the first processing core according to the multi-threadedness of the multi-core processor if the operation bottleneck occurs at the first processing core.

2. The adjusting performance method according to claim 1, wherein the step (c) further comprises the steps of:
(c1) providing a look-up table; and
(c2) adjusting the operating frequency of the first processing core to the value that the multi-threadedness of the multi-core processor corresponds to in the look-up table.

3. The adjusting performance method according to claim 1, wherein the step (c) further comprises the steps of:
(c3) determining the range of the multi-threadedness of the multi-core processor;
(c4) decreasing the operating frequency of the first processing core when the multi-threadedness of the multi-core processor is greater than a first default value; and
(c5) increasing the operating frequency of the first processing core when the multi-threadedness of the multi-core processor is less than a second default value, wherein the first default values is greater than the second default value.

4. The adjusting performance method according to claim 3, wherein the multi-core processor can operate in the first to N-th operating setting, N is a positive integer, and in the step (a), the multi-core processor is in the i-th operating setting, and the step (c4) further comprises the steps of:
determining whether the i equals to one, and setting the multi-core processor in the (i−1)-th operating setting to decrease the operating frequency of the first processing core if the i does not equal to one; and maintaining the multi-core processor in the i-th operating setting and returning to the step (a) if the i equals to one; and
the step (c5) further comprises:
determining whether i equals to N, and setting the multi-core processor in the (i+1)-th operating setting to increase the operating frequency of the first processing core if the i does not equal to N; and maintaining the multi-core processor in the i-th operating setting and returning to the step (a) if the i equals to N.

5. The adjusting performance method according to claim 1, wherein the step (c) further comprises the step of adjusting the multiplier, the clock or the power supply of the first processing core.

6. The adjusting performance method according to claim 5, wherein the multi-core processor is operatively connected to a control unit and a clock generator, the control unit is operatively connected to the processing cores and the clock generator, respectively, the clock generator is operatively connected to the processing cores, respectively, and the control unit adjusts the clock of the first processing core by controlling the clock generator.

7. The adjusting performance method according to claim 6, wherein the control unit controls the clock generator by an Inter-integrated Circuit (I²C) bus.

8. The adjusting performance method according to claim 5, wherein an Inter-integrated Circuit (I²C) bus is used to adjust the clock of the first processing core in the step (c).

9. The adjusting performance method according to claim 1, wherein the step (c) further comprises the step of adjusting the operating frequency, the power state or the power supply of the second processing core according to the multi-threadedness of the multi-core processor.

10. The adjusting performance method according to claim 1, wherein detecting the multi-threadedness of the multi-core processor and the load of the processing cores is used by a hardware monitoring means or a software monitoring means in the step (a).
